(19) United States
(12) Patent Application Publication
(10) Pub. No.: US 2012/0072779 A1
(43) Pub. Date: Mar. 22, 2012

(54) MEMORY LEAK MONITORING DEVICE AND METHOD FOR MONITORING MEMORY LEAK

(75) Inventor: Tomoyasu TAKAI, Kawasaki (JP)

(73) Assignee: Fujitsu Limited

(21) Appl. No.: 13/240,395

(22) Filed: Sep. 22, 2011

Related U.S. Application Data
(63) Continuation of application No. PCT/JP2009/001503, filed on Mar. 31, 2009.

(51) Int. Cl. G06F 11/30

(52) U.S. Cl. 714/47.1; 714/E11.179

(57) ABSTRACT

The memory leak monitoring device for monitoring a memory leak occurring by an executed program reserving a memory area, the memory leak monitoring device comprising a retention period acquisition unit that acquires a retention period of each program indicating an elapsed time after a memory area used by the program is reserved, and a detection unit that detects a program in which a memory leak may occur by comparing the acquired retention period with a reference time.

### CROSS-REFERENCE TO RELATED APPLICATION

This application is a continuation application of International Application JP2009/001503 filed on Mar. 31, 2009 and designated the U.S., the entire contents of which are incorporated herein by reference.

### FIELD

The embodiments of the present invention relate to a memory leak monitoring device and method for monitoring memory leak.

### BACKGROUND

Normally, resources are allocated as available hardware resources to a program executed in a computer as an information processing device. A memory area available to a program is reserved as apart of the resources. A program being executed is called a “process”. The process is broadly classified into a system process (hereafter referred to as a “kernel process”) for realizing a part of the function of the OS (operation system) and a user process (for example, an application program to be executed) performed by an instruction of a user.

The OS is loaded with a management function of the memory area. The management function dynamically determines the memory area depending on plurality of parameters specified in a program. The determined memory area is reported to the program using, for example, the leading address and the size of the memory area.

The reserved memory area is released by a memory release instruction from the program. However, when no memory release instruction is issued from the program due to a bug etc., the management function does not release the memory area although the memory area is not necessary. A so-called “memory leak” occurs in the unreleased memory area.

The OS in a virtual storage system divides virtual memory into a kernel space and a user space. The kernel space is the entire memory area available to the kernel process such as a kernel, device drivers, etc., and is strictly reserved. The user space is a memory area individually reserved for a user process.

The application executed on the OS is normally a user process. The memory area (user space) allocated to a user process is automatically released by the termination of the program (for example, an application) . Therefore, the memory area on which a memory leak has occurred can be released by the termination of the program.

On the other hand, unlike the user process, there is no opportunity of a release for the memory area on which a memory leak has occurred in the kernel process such as a system call, a daemon of a kernel, an interrupting process, etc. Basically, the memory area on which a memory leak has occurred cannot be released unless the OS is terminated. Accordingly, the memory area on which a memory leak has occurred is accumulated during the operation of the OS.

The memory leak which has occurred in the kernel space reduces an available memory area, and impairs the operation of the OS. If the memory area of the memory leak grows, the memory area for continuing the operation cannot be reserved, thereby stopping the execution of an application. There can be a case in which the entire device executing the OS goes down.

The OS can be loaded as an embedded OS (real time OS) into an embedded system. The embedded system is a computer system developed for a specific use, and is often loaded into a device for a continuous use for a long period such as a vending machine, an automatic ticket machine, etc. With the devices, even a small memory leak can impair the operation of an embedded OS by largely decreasing the memory resources as a result of the accumulation of the memory leak for a long period.

To annihilate the memory leaks, it is necessary to detect and remove the cause of the occurrence of all memory leaks during the debugging of a program. However, it is practically hard to guarantee the continuous operation of a program for a long period by covering all operation conditions during the debugging. Under the circumstances, taking appropriate measures against the memory leaks occurring in a kernel space is strongly important. The same holds true with the case in which memory areas are allocated to a plurality of processes in a fixed address space different from a kernel space.

As a memory leak monitoring device, it is known to prepare a system (interface) for notifying the management function of the maximum retention period of a memory area reserved by a process and a warning period so that the management function can determine whether or not the reserved memory area is to be released. Thus, the management function can issue a warning when the warning period has passed since the reservation of the memory area, and when the maximum retention period elapses, the memory area is forcibly released.

To notify the management function of the maximum retention period etc., each program whose memory leak is to be monitored has to be amended. However, amending a program is very costly. Therefore, it is preferable to take measures against the memory leaks occurring in a kernel space by avoiding an amendment to each program whose memory leak is to be monitored, that is, by preparing no new interface.

A reference technological document can be Japanese Laid-open Patent Publication No. 2002-108698 and Japanese Laid-open Patent Publication No. 2008-3945.

### SUMMARY

The memory leak monitoring device for monitoring a memory leak occurring by an executed program reserving a memory area, the memory leak monitoring device comprising a retention period acquisition unit that acquires a retention period of each program indicating an elapsed time after a memory area used by the program is reserved, and a detection unit that detects a program in which a memory leak may occur by comparing the acquired retention period with a reference time.

### BRIEF DESCRIPTION OF DRAWINGS

FIG. 1 is an explanatory view of a configuration of a computer system generated using a system control device loaded with the memory leak monitoring device according to an embodiment of the present invention;

FIG. 2 is an explanatory view of a software configuration of a management board 20 loaded with the memory leak monitoring device according to an embodiment of the present invention;

FIG. 3 is an explanatory view of a data configuration of a memory area list 212;

FIG. 4 is an explanatory view of a data configuration of an exclusion list 221;

FIG. 5A is an explanatory view of an example of reserving a memory area in a kernel process not to be entered in the exclusion list 221;

FIG. 5B is an explanatory view of an example of reserving a memory area in a kernel process excluded from monitor targets;

FIG. 6 is a histogram of explaining the number of memory areas with reference to the retention period;

FIG. 7 is a flowchart of a memory reserving process;

FIG. 8 is a flowchart of a memory releasing process;

FIG. 9 is a flowchart of a memory leak monitoring process;

FIG. 10 is a flowchart of a process performed for display of the information about a memory leak by a device management application;

FIG. 11 is a flowchart of a process performed for each record;

FIG. 12 is a flowchart of a threshold setting process;

FIG. 13 is an explanatory view (variation example) of a data configuration of the exclusion list 221; and

FIG. 14 is a flowchart (variation example) of a process performed on each record.

### DESCRIPTION OF EMBODIMENTS

Embodiments of the memory leak monitoring device are described below with reference to the attached drawings.

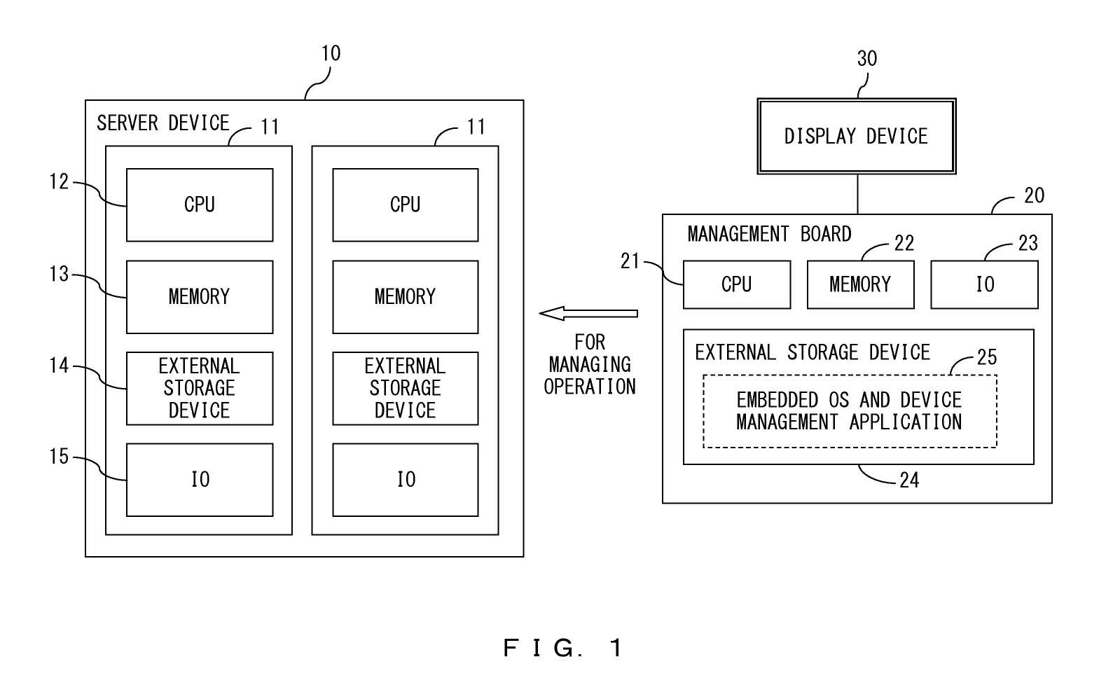

FIG. 1 is an explanatory view of a computer system as an information processing device built using a system control device loaded with a memory leak monitoring device according to an embodiment of the present invention and a server device. As illustrated in FIG. 1, the computer system has a server device 10 to which a management board (MMB) 20 as a service processor (SVP) for management of the server device 10 is connected, and has a display device 30 connected to the management board 20. The memory leak monitoring device according to the present embodiment is loaded into the management board 20.

The server device 10 has a configuration in which processing units 11 as a plurality of system boards (SB) are interconnected by crossbars as data transfer devices not illustrated in the attached drawings. A CPU 12, memory 13, an external storage device 14, and an IO (input/output) device 15 are loaded into the processing unit 11 as illustrated in, for example, FIG. 1. The communications with the management board 20 are performed through the IO device 15.

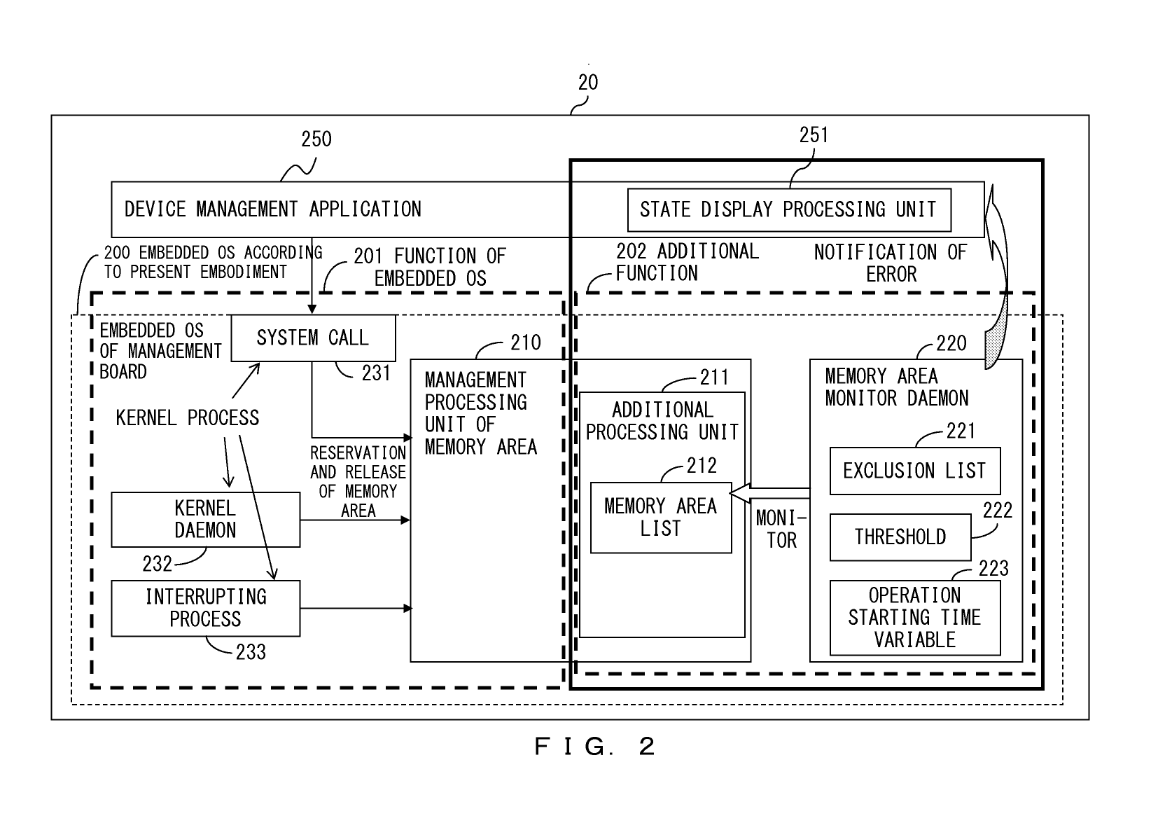

The management board 20 has a configuration including a CPU 21, memory 22, an IO device 23, and an external storage device 24 as illustrated in FIG. 2. The communications with the server device 10 are performed through the IO device 23. The external storage device 24 stores an embedded OS and a program group 25 such as a device management application as a program for management of the server device 10 etc.

FIG. 2 is an explanatory view of a software configuration of management board 20. As illustrated in FIG. 2, an embedded OS 200 according to the present embodiment, and a device management application 250 executing on the embedded OS 200 are loaded into the management board 20 as the program group 25. The embedded OS 200 and the device management application 250 configure an embedded system for the management board 20 for control of the system of the management board 20.

The embedded OS 200 is constructed by adding an additional function 202 for monitoring a memory leak according to the present embodiment to a function 201 of the embedded OS loaded with a management processing unit 210 of a memory area as a program for managing a memory area.

As a process for realizing the function 201 of the embedded OS, FIG. 2 illustrates a system call 231, a kernel daemon 232, and an interrupting process 233. The system call 231 is performed so that an application can call the function 201 of the embedded OS. The kernel daemon 232 is a subprogram resident for process control etc. An interrupting process is an executable process for performing a hardware interruption. The kernel processes are assigned a memory area from inside the kernel space as a fixed memory resource reserved by a management processing unit 211 of a memory area. Processes whose memory leak are to be monitored corresponding to all kernel processes operating on he embedded OS 200.

The additional function 202 is loaded with a memory area monitor daemon 220 as a program for monitoring a memory leak. The memory area monitor daemon 220 operates as one of the kernel processes.

Furthermore, the management processing unit 210 of a memory area is loaded with the additional processing unit 211 as its subprogram. The additional processing unit manages the memory area list 212 indicating the memory area allocated to each kernel process. The memory area list 212 refers to, for example, array variables stored in the memory 22.

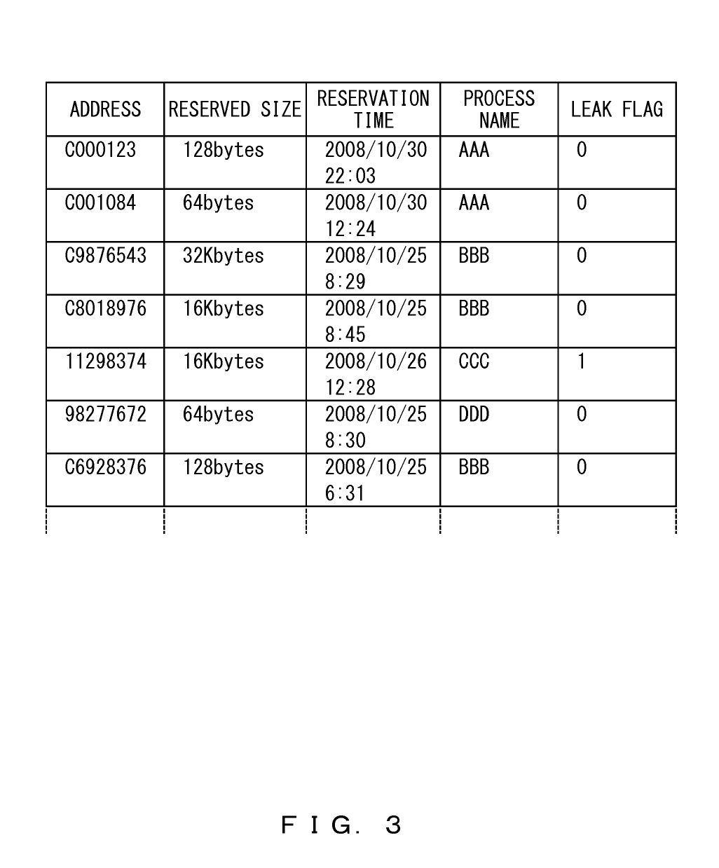

FIG. 3 is an explanatory view of a data configuration of the memory area list 212. As illustrated in FIG. 3, the memory area list 212 has a record provided for each memory area reserved from inside the kernel space and storing the data relating to the memory area. Each record stores as data an address, a reserved size, a reservation time, a process name, and a leak flag. The address is a leading address of a reserved memory area. The reserved size is the number of addresses in the memory area. The reservation time is the time in which a corresponding memory area is allocated to a kernel process. The time is, for example, the current time kept by a hard timer loaded into the CPU 21. The process name is identification data of the process which has allocated the memory area. The leak flag indicates the possibility that a memory leak has occurred. “0” indicates that there is no possibility that a memory leak has occurred. “1” indicates that there is the possibility.

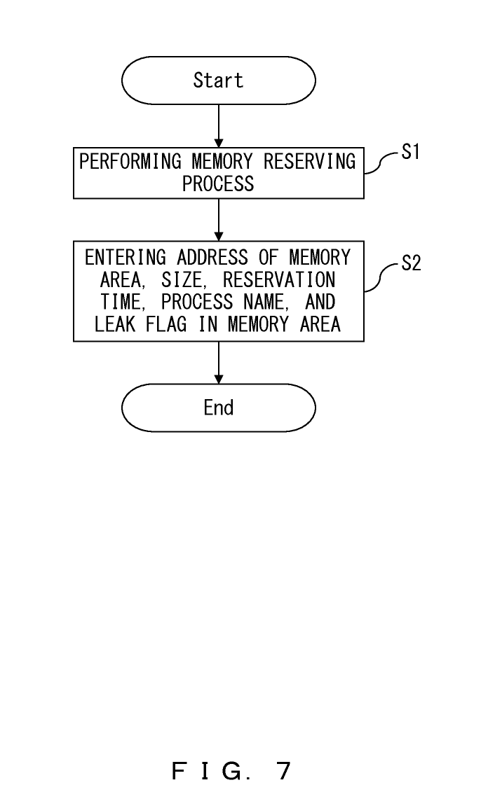

A memory area is reserved and released by a kernel process at a request issued to the management processing unit 210 of the memory area. When a request to allocate a memory area is issued from a kernel process, the management processing unit 210 performs the memory reserving process illustrated in FIG. 7.

In the memory reserving process, a reserving process of a memory area is performed, and the address (leading address) and the size of the memory area reserved in the reserving process are passed to the kernel process first in step S1. Next, in step S2, in addition to the address and the size, a reservation time, a process name, and a leak flag having the value of 0 are entered in the memory area list 212. After the entry, the memory reserving process terminates.

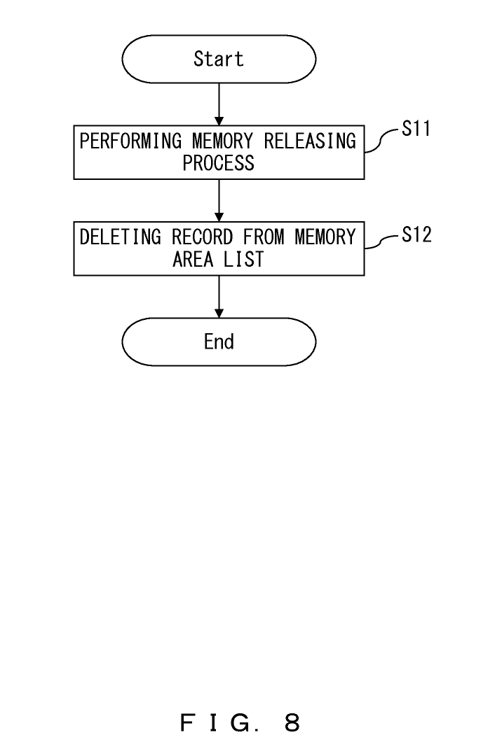

On the other hand, when a request to release a memory area is issued from a kernel process, the management processing unit 210 of the memory area performs the memory releasing process illustrated in FIG. 8. In the memory releasing process, the following process is performed.

First in step S11, the process for releasing the memory area requested from the kernel process is performed. Then in step S12, the record corresponding to the memory area to be released is extracted and deleted, thereby performing the memory releasing process. Then, the memory releasing process terminates.

The management processing unit 211 is realized by performing the processes in steps S2 and S12.

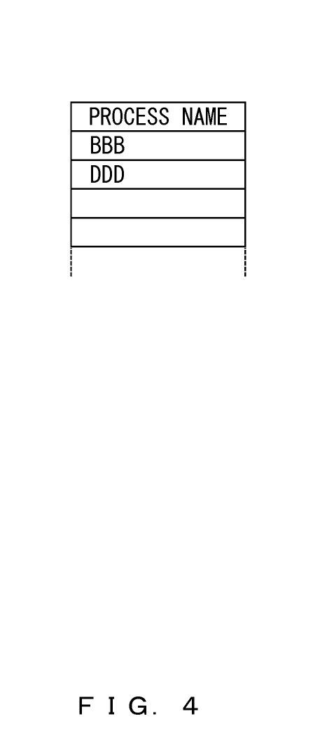

The memory area monitor daemon 220 manages an exclusion list 221, a threshold 222, and an operation starting time variable 223. The exclusion list 221 is used in managing the process to be excluded from the memory leak monitor targets from the kernel process. As illustrated in FIG. 4, the identification data (the process name in this example) of the process to be excluded from the monitor targets is entered. In the present embodiment, as described later, the possibility that a memory leak has occurred is determined by considering the elapsed time (retention period) after the reservation of a memory area. The threshold 222 is a reference time to be compared with the retention period to determine the possibility. The operation starting time variable 223 is a variable to which the operation starting time of the embedded OS 200 is substituted. What is practically substituted to the operation starting time variable 223 is the time at which the memory area monitor daemon 220 is activated. The exclusion list 221 and the threshold 222 are data provided in advance by an administrator etc.

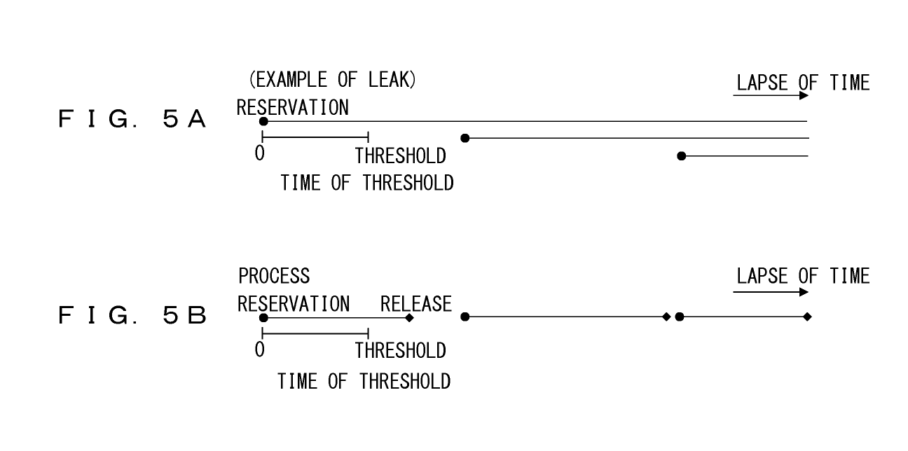

FIGS. 5A and 5B are explanatory views of the kernel process to be entered in the additional function 202. FIG. 5A is an example of reserving a memory area in a kernel process not to be entered in the memory area list 212. FIG. 5B is an example of reserving a memory area in the kernel process to be excluded from the monitor targets. In FIGS. 5A and 5B, a black dot indicates the time at which a memory area is reserved, and a black square indicates the time at which a memory area is released. Thus, the line connecting the black dot to the black square indicates the retention period in which the memory area is reserved.

As illustrated in FIG. 5A, when a memory leak occurs in a kernel process, the memory area reserved in the process is not released unless the embedded OS 200 is terminated or it is forcibly released. For the kernel process in which there is the possibility that the memory leak has occurred, the value of the leak flag is set to 1 when the retention period exceeds the threshold 222. On the other hand, as illustrated in FIG. 5B, it is not preferable to define the retention period exceeding the threshold 222 as the condition for releasing the memory area in the kernel process whose memory area can be released when the retention period exceeds the threshold 222. Because it is considered that a relatively long time is required to perform a process. Therefore, the kernel process can be prevented from releasing the memory area not to be released by entering the kernel process in the exclusion list 221.

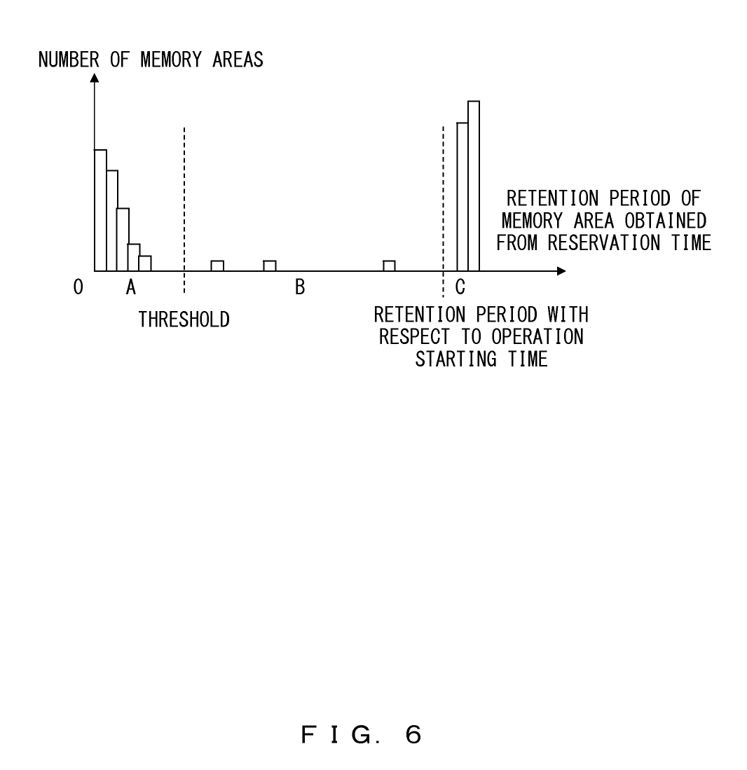

FIG. 6 is a histogram for explanation of the number of memory areas by the retention period. The vertical axis indicates the number of memory areas, an the horizontal axis indicates the retention period (based on the operation starting time or the reservation time).

Some kernel processes release memory areas reserved in a relatively short time such as the interrupting process 233, the system call 231, etc., and others do not release reserved memory areas for a long time. The former belong to the range A, and the latter to the ranges B and C. The area in the range C is a memory area reserved by a process performed when or immediately after the embedded OS 200 is activated. Therefore, the bug of a memory leak occurring in the memory area can be easily detected during the debugging. Therefore, in the present embodiment, the memory area in the range C is excluded as a reliable memory area from the monitor targets, and only the memory areas having the retention period in the range B between the ranges A and C are defined as monitor targets. It is assumed that all memory areas in the range B have the possibility of memory leaks. However, although the memory area belongs to the range B, it is excluded from the monitor targets by storing it in the exclusion list 221 if it has been reserved by a reliable kernel process. Thus, a memory leak can be monitored using the threshold 222 by designating with high accuracy a kernel process in which the memory leak has occurred.

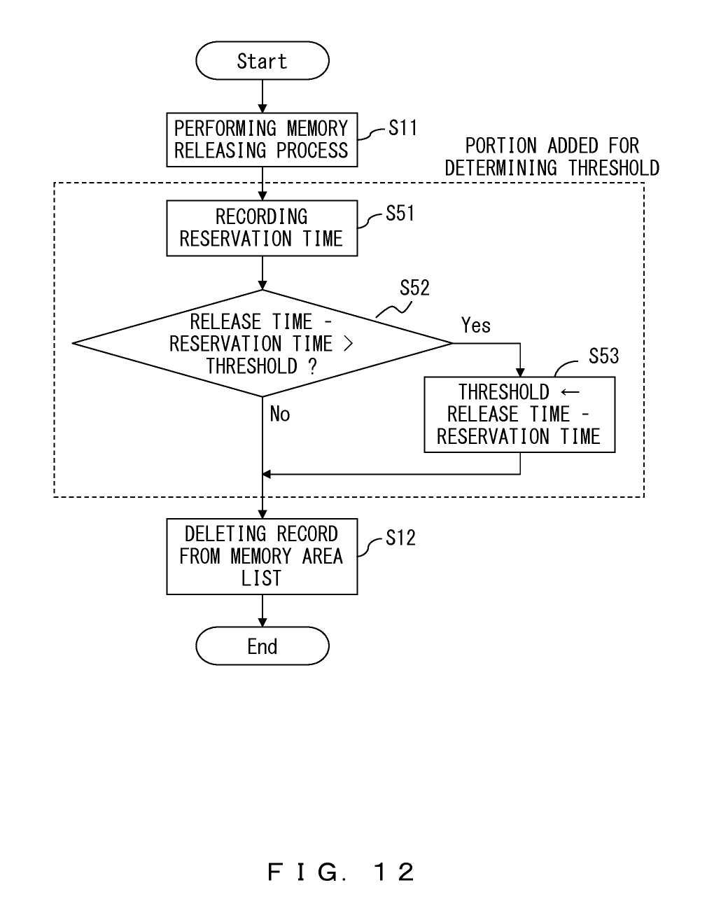

The threshold 222 can be set by performing the threshold setting process as illustrated in FIG. 12, for example, during the debugging. The setting process is to extract a time as an option to be set as the threshold 222 by reserving a memory area. In the memory releasing process illustrated in FIG. 8, the processes in steps S51 through S53 are performed between steps S11 and S12. The added processes are described below in detail.

In step S51, a release time is recorded. In the next step S52, it is determined whether or not the result (retention period) obtained by subtracting the reservation time from the release time is larger than the previous threshold. If the calculated retention period is larger than the threshold, the determination is YES, and control is passed to step S12 after the retention period is set as a new threshold in step S53. If the retention period is equal to or smaller than the threshold, the determination is NO, and control is passed to step S12.

It is preferable that, in the threshold setting process, a threshold is extracted by regarding as a target a process not to be regarded as a monitor target.

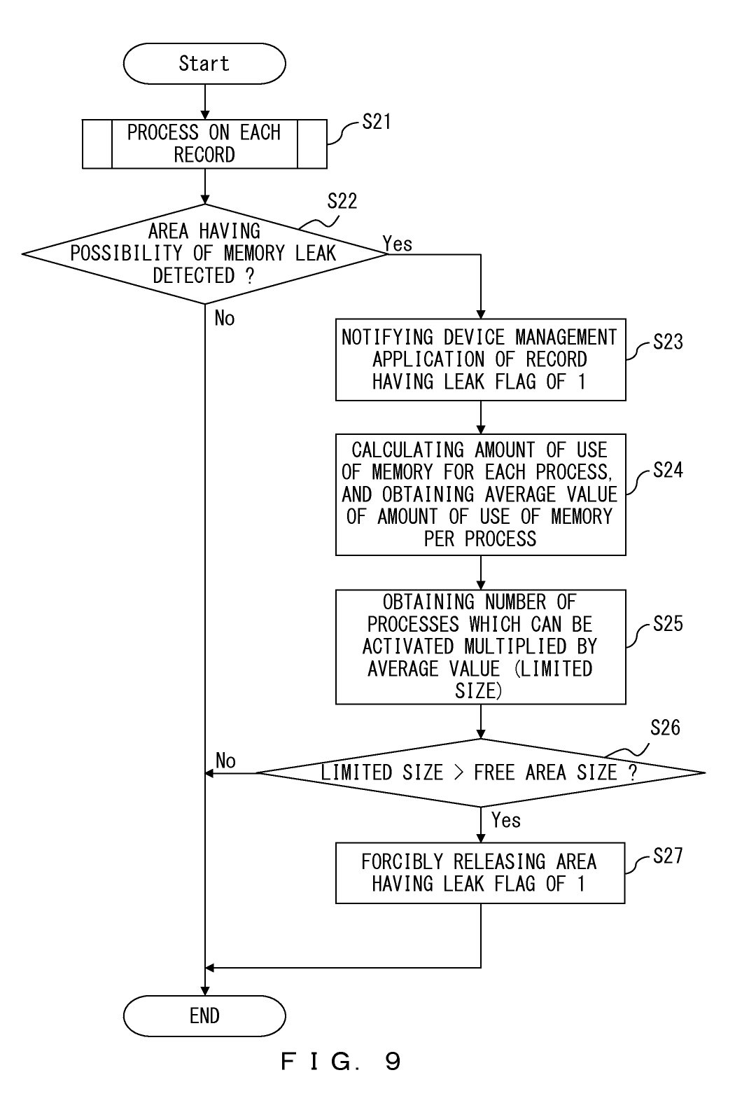

After the activation by activating the embedded OS 200, the memory area monitor daemon 220 acquires the current time from, for example, a hard timer, and substitutes the time to the operation starting time variable 223. Afterwards, the memory leak monitoring process illustrates in FIG. 9 is performed, for example, at specified time intervals or with a specified timing. The memory leak monitoring process is described below in detail.

First in step S21, the process corresponding to each record for determination of the possibility that there occurs a memory leak is performed, every record (memory area) constituting the memory area list 212. Next in step S22, it is determined whether or not a memory area having the possibility of a memory leak by performing the process corresponding to each record. When a memory area having the possibility is detected, the determination is YES, thereby passing control to step S23. When a memory area having the possibility is not detected, the determination is NO, thereby terminating the memory leak monitoring process.

In step S23, a record having the leak flag of 1 in the memory area list 212 is reported to the device management application 250. In the next step S24, the amount of the use of memory for each process, that is, the size of the memory area is calculated, and an average value of the amount of the use of the memory per process is obtained. In the next step S25, the specified number of processes which can be activated is multiplied by the obtained average value. The multiplication result is hereafter referred to as a “limited size”.

In step S26 after step S25, it is determined whether or not the limited size is larger than the free area size of the memory 22 which can be allocated to the kernel space. If the limited size is larger than the free area size, the determination is YES, and the memory area managed by the record having the leak flag of 1 is forcibly released in step S27, thereby terminating the memory leak monitoring process. If the limited size is equal to or smaller than the free area size, the determination is NO, thereby terminating the memory leak monitoring process.

The limited size becomes larger as the average value of the amount of the use of memory per process becomes larger. This means that there is a strong possibility that the process uses a larger amount of memory resources of the memory 22. The free area size is the maximum value of the memory resources of the memory 22 reserved by a process. Thus, it is determined in step S26 whether or not there is relatively room for the memory resources of the memory 22.

The determination of the room is not limited to the description above. For example, the room can be determined by checking whether or not a preset rate of memory area has been reserved from the kernel space. In this case, the average value can be considered.

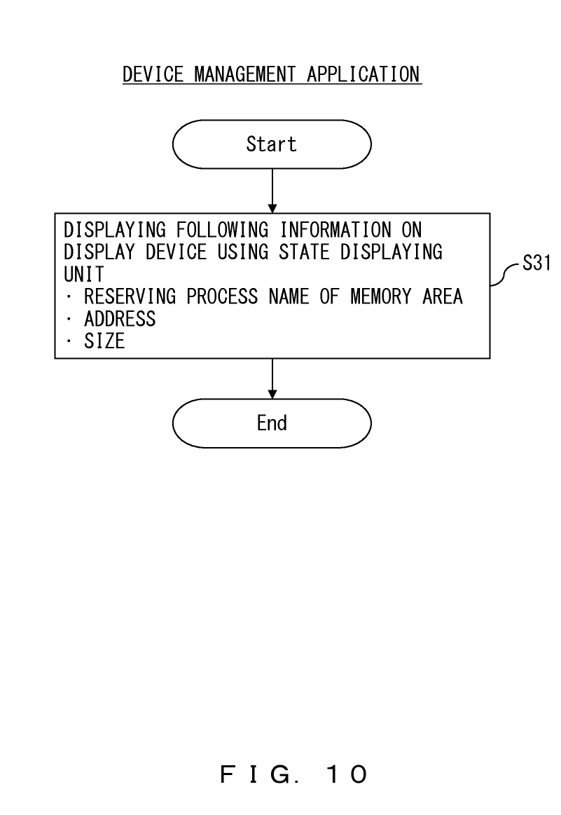

The device management application 250 is loaded with a state display processing unit 251 as a subprogram. The state display processing unit 251 displays the information about a memory leak which may have occurred on a user on the display device 30 using the record reported from the memory area monitor daemon 220. The state display processing unit 251 is realized by the device management application 250 performing the state display process illustrated in FIG. 10. In the state display process, as illustrated in FIG. 10, a process name, an address, and a size are displayed for each memory area in step S31.

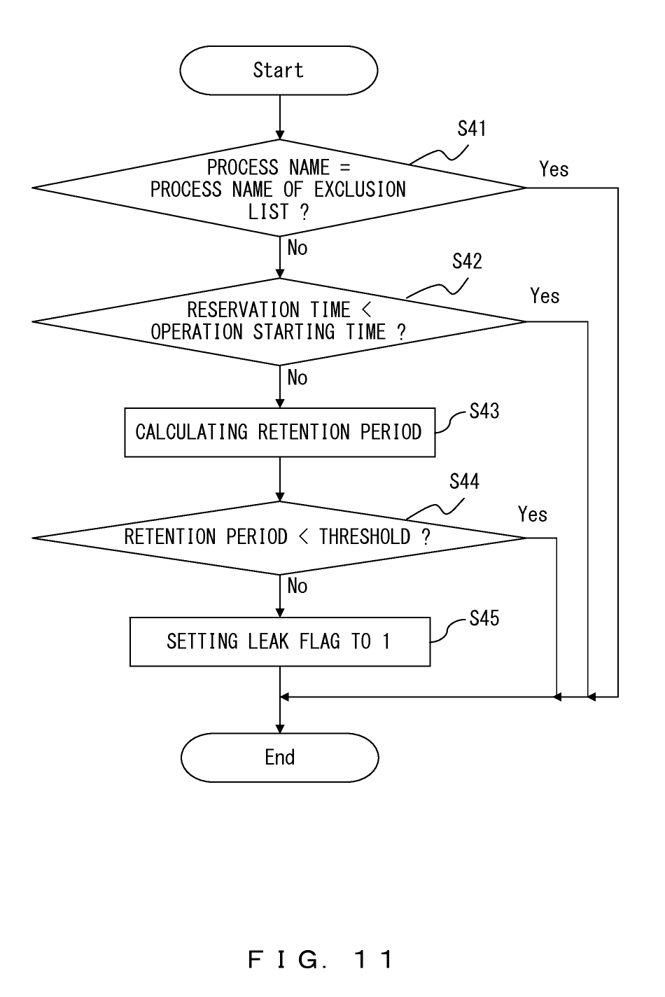

FIG. 11 is a flowchart of the process for each record executed in step S21. The process is described below in detail with reference to FIG. 11. In this example, only a portion corresponding to one record is extracted and illustrated in FIG. 11 for convenience.

First in step S41, it is determined whether or not the process name of a target record is entered in the exclusion list 221. If the process name has been entered in the exclusion list 221, the determination is YES, and the process for one record is terminated here. If the process name has not been entered, the determination is NO, and control is passed to step S42.

In step S42, it is determined whether or not the reservation time precedes the operation starting time. If the target memory area has been reserved before the activation of the memory area monitor daemon 220, the determination is YES, and the process for the record terminates. If the reservation time follows the operation starting time, the determination is NO, and control is passed to step S43.

In step S43, the elapsed time from the reservation time is calculated as a retention period. In step S44, it is determined whether or not the retention period is shorter than the threshold 222. If the retention period is shorter than the threshold 222, the determination is YES, and the process for one record is terminated. If the retention period is equal to or longer than the threshold 222, the determination is NO, and the leak flag of the target record is set to 1 in step S45, and then the process for one record is terminated.

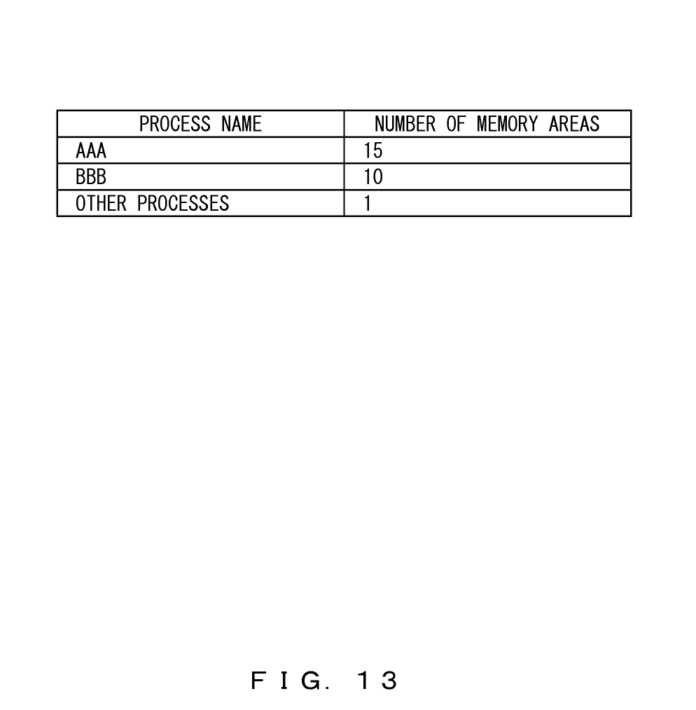

According to the present embodiment, the exclusion list 221 stores only the process name, but other information can also be stored together. For example, as illustrated in FIG. 13, the number of memory areas can also be stored together because the same process can reserve a plurality of memory areas. Thus, if the number of memory areas (maximum number of memory areas which can be reserved in the process) is also entered, an abnormally increasing number of memory areas (records) can be correctly avoided.

Thus, according to the present embodiment, a memory area (program) in which there is the possibility that a memory leak occurs is detected, thereby avoiding the necessity to change the program of a kernel process to be monitored. Therefore, as compared with the case in which the program of a kernel process is amended, a memory leak can be monitored at a lower cost.

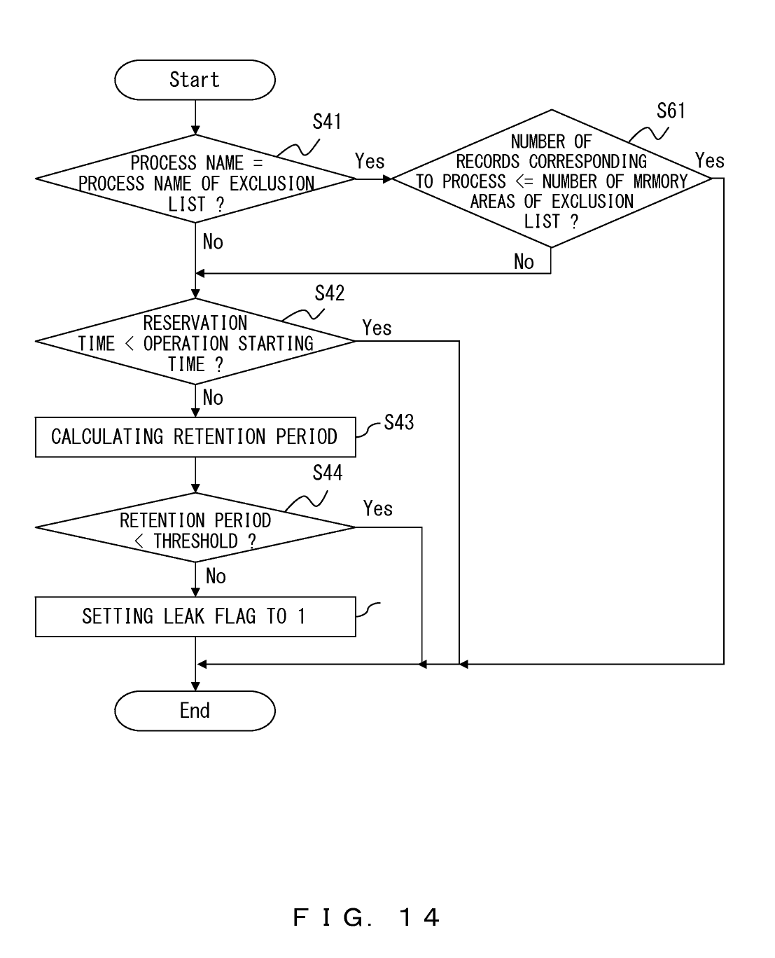

When the exclusion list 221 as illustrated in FIG. 13 is adopted, the process performed on each record illustrated in FIG. 11 can be varied as illustrated in FIG. 14. In FIG. 14, the determination in step S41 is YES, thereby passing control to step S61, and it is determined whether or not the number of records corresponding to the process, that is, the total number of records storing the process names of target records, is smaller than the number of memory areas entered in the exclusion list 221. When the total number of records is smaller than the number of memory areas, the determination is YES, thereby terminating the process on each record. If the total number of records is larger than the number of memory areas, then the determination is NO, thereby passing control to step S42.

According to the present embodiment, the program of the portion enclosed by the bold lines in FIG. 2 is added, and the embedded OS 200 and the device management application 250 included in the added portion are executed by the management board (computer) 20, thereby realizing the memory leak monitoring device. However, the memory leak monitoring device can also be realized in other methods. Thus, the function of loading the memory leak monitoring device into a realizing memory leak monitor program can load it into one program or a plurality of programs separately. The memory leak monitor program can be distributed through a computer accessible record medium or a communication network.

1. A memory leak monitoring device for monitoring a memory leak occurring by an executed program reserving a memory area, the memory leak monitoring device comprising:
a retention period acquisition unit that acquires a retention period of each program indicating an elapsed time after a memory area used by the program is reserved; and
a detection unit that detects a program in which a memory leak may occur by comparing the acquired retention period with a reference time.

2. The memory leak monitoring device according to claim 1, further comprising
a memory area release unit that forcibly releases the memory area reserved by the detected program based on an unused area of whole memory area when the whole memory area is determined as memory area reserved by the program in which the memory leak is to be detected.

3. The memory leak monitoring device according to claim 1, wherein
the detection unit detects the memory leak in programs other than a program corresponding to identification information of a program having no necessity to detect the memory leak based on an exclusion list in which the identification information is entered.

4. The memory leak monitoring device according to claim 1, wherein
the program is executed as a system process for realizing a function of an operating system operated in the memory leak monitoring device.

5. The memory leak monitoring device according to claim 1, wherein
the reference time is set based on the retention period from a reservation of a memory area by a program for detecting the memory leak to a release of the memory area.

6. The memory leak monitoring device according to claim 3, wherein
the exclusion list stores a maximum number of memory areas indicating a maximum area number which can be reserved by each program, and
the detection unit monitors a program that reserves memory areas exceeding the maximum area number in the programs entered in the exclusion list.

7. A memory leak monitoring method for a memory leak monitoring device that monitors a memory leak occurring by an executed program reserving a memory area, the memory leak monitoring method comprising:
acquiring a retention period of a program indicating an elapsed time after a memory area used by the program is reserved; and
detecting a program in which a memory leak may occur by comparing the acquired retention period with a reference time.

8. The memory leak monitoring method according to claim 7, further comprising
forcibly releasing the memory area reserved by the detected program based on an unused area of whole memory area when the whole memory area is determined as memory area reserved by the program in which the memory leak is to be detected.

9. The memory leak monitoring method according to claim 7, further comprising
the detecting detects the memory leak in programs other than a program corresponding to identification information of a program having no necessity to detect the memory leak based on an exclusion list in which the identification information is entered.

10. The memory leak monitoring method according to claim 7, wherein
the reference time is calculated by a processor of the memory leak monitoring device performing the process comprising:
calculating a retention period of each program in which the memory leak is to be detected from a reservation of a memory area to a release of the area by the program; and
extracting the reference time from the retention period calculated in the calculating.
